(19) United States
(12) Patent Application Publication
(10) Pub. No.: US 2009/0063395 A1
(43) Pub. Date: Mar. 5, 2009

(54) MAPPING LOG SETS BETWEEN DIFFERENT LOG ANALYSIS TOOLS IN A PROBLEM DETERMINATION ENVIRONMENT

(75) Inventors: Nellie Klump, Toronto (CA); Christine N. Knight, Toronto (CA); Eric Labadie, Toronto (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/847,514

(22) Filed: Aug. 30, 2007

(51) Int. Cl. G06F 17/30

(52) U.S. Cl. 707/2; 707/E17.001

(57) ABSTRACT

A method is provided for mapping analysis data between a first data analysis tool configured to interpret analysis data expressed in a first format to a second data analysis tool configured to interpret analysis data expressed in a second format. The method comprises receiving a set of analysis data expressed in the first format from the first data analysis tool; receiving an indication of the second format; identifying a set of common analysis data from the set of analysis data using a set of common analysis data properties and a first context, the first context providing a set of rules for expressing the set of common analysis data properties in the first format; and generating a representation of the set of common analysis data in the second format using a second context. The first context provides a set of rules for expressing the set of common analysis data properties in the first format. The second context provides a set of rules for expressing the set of common analysis data properties in the second format.

### CROSS-REFERENCE TO RELATED APPLICATIONS

This application contains subject matter that is related to the subject matter of the following co-pending application, which is assigned to the same assignee, International Business Machines Corporation of Armonk, N.Y., as this application. The below listed application is hereby incorporated herein by reference in its entirety: U.S. patent application Ser. No. 11/836,533, filed by Bourne et al. on Aug. 9, 2007.

### BACKGROUND OF THE INVENTION

1. Field of the Invention

This invention relates to analysis of log files in a problem determination environment, and particularly to the mapping of log file information between different log analysis components.

2. Description of Background

When a problem affecting the operational status or availability of resources in computer system or environment occurs, the first priority is to remedy the problem and restore the affected applications or components as quickly as possible. Once system recovery has been accomplished, the next hurdle is to detect, isolate, and diagnose the root cause or source of the problem, which could be, for example, a program component error, a machine failure, an environmental failure such as a power loss, or a user error. This process, known as problem determination, is used for preventing the recurrence of incidents, improving system performance and availability, and reducing support costs.

Modern computer systems are implemented with application and component-monitoring tools that generate copious amounts of system log data. In computerized data logging, a computer program may automatically record event data in a certain scope to provide an audit trail containing valuable information for managing the system, localizing failures, and aiding in recovery. In many cases, the log files are esoteric, machine-level representations and must be subjected to log analysis to make sense of them. Problem determination therefore necessarily involves the use of automated procedures and/or human administration to analyze sets of log files of event data compiled from various components of an infrastructure.

The increased use of distributed computing, with its growing complexity of heterogeneous systems, has made problem determination significantly more complex. Most data logging is focused on reporting data that a product developer considers important for diagnosing the problem in a single product. In performing problem determination on these systems, then, it is very useful to combine log file entries from multiple sources to yield correlations between seemingly unrelated events on different servers. While there are automated tools that can adequately address problem determination in the case of individual or small sets of products, writing management software that automates problem determination in large, diverse systems is far more complicated.

Much of this difficulty can be attributed to the fact that log files are separately generated by separate components that differ in the reporting format they use to specify logging data, and proprietary methods are also common. Log files contain a variety of content in differing formats because solutions are built using disparate pieces and parts, often with products from multiple vendors. Moreover, products from the same vendor may use different log file formats due to vendor acquisitions. Most products generate log file or event data for which the interpretation requires the availability of contextual information. This context, however, is frequently maintained only in the minds of developers and analysts who are intimately familiar with the specific application that generates the event. This lack of mutual context makes it difficult to correlate problem determination data from different products and products on different servers, as each product experiencing the same problem may report the problem in a different format. Each product's problem determination data, such as trace records, log records and messages, can only provide a view through a small window into the overall system problem. This complexity increases with the complexity and size of a system.

Further complicating matters, administrators within the same company may not all use different analysis tools (for example, Rich Client Platform Log Analyzer, Portal Log Analyzer, Eclipse Log and Trace Analyzer, SWG Tooling, etc.) to identify and isolate the cause of a problem. Problem determination tools for analyzing sets of logically related log files, however, are not provided with a means of exchanging this information with each other. Each analysis tool may have its own proprietary format for describing a set of log files, as well as application specific information related to loading a log set in the application.

### SUMMARY OF THE INVENTION

The shortcomings of the prior art can be overcome and additional advantages can be provided through exemplary embodiments of the present invention that are related to a method for mapping analysis data between a first data analysis tool configured to interpret analysis data expressed in a first format to a second data analysis tool configured to interpret analysis data expressed in a second format. The method comprises receiving a set of analysis data expressed in the first format from the first data analysis tool; receiving an indication of the second format; identifying a set of common analysis data from the set of analysis data using a set of common analysis data properties and a first context, the first context providing a set of rules for expressing the set of common analysis data properties in the first format; and generating a representation of the set of common analysis data in the second format using a second context. The first context provides a set of rules for expressing the set of common analysis data properties in the first format. The second context provides a set of rules for expressing the set of common analysis data properties in the second format.

The shortcomings of the prior art can also be overcome and additional advantages can also be provided through exemplary embodiments of the present invention that are related to computer program products and data processing systems corresponding to the above-summarized method are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that can be implemented to provide for mapping analysis data between analysis tools configured to interpret analysis data expressed in differing formats by generating and using context information specific to the data analysis tools. Exemplary embodiments of the present invention can be implemented to enable separation of application-level context information from the content of sets of analysis data to make data analysis in heterogeneous computing environments more manageable and efficient.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 is a schematic diagram that illustrates an operational configuration of an exemplary embodiment of a problem determination reporting environment.

FIG. 2 is a schematic diagram that illustrates an operational configuration of an exemplary embodiment of a web service system.

FIG. 3 a flow diagram that provides a method of generating an output file in a context suitable for interpretation by a specified log analysis tool in accordance with an exemplary embodiment of the present invention.

FIG. 4 illustrates an exemplary embodiment of a graphical WSDL interface defining a context generator web service

FIGS. 5a and 5b are schematic diagrams that illustrate exemplary embodiments of operations performed by the exemplary WSDL interface of FIG. 4.

FIGS. 6a and 6b are schematic diagrams that illustrate further exemplary embodiments of operations performed by the exemplary WSDL interface of FIG. 4.

FIG. 7 is a schematic diagram that illustrates a hardware configuration of computer system for a web service application server in accordance with exemplary embodiments of the present invention.

The detailed description explains exemplary embodiments of the present invention, together with advantages and features, by way of example with reference to the drawings. The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

### DETAILED DESCRIPTION OF EXEMPLARY EMBODIMENTS

The following disclosure describes exemplary embodiments of techniques and mechanisms for mapping logically related sets of log files, or log sets, between different log analysis tools in a problem determination environment so that information generated from one log analysis tool can be used by other analysis tools. In particular, the process of mapping log sets between different log analysis tools is performed by generating and using application-specific context information. The following is intended to provide a detailed description of exemplary embodiments of the invention and should not be taken to be limiting of the invention itself. Rather, any number of other embodiments may fall within the scope of the invention, which is defined in the claims following the description.

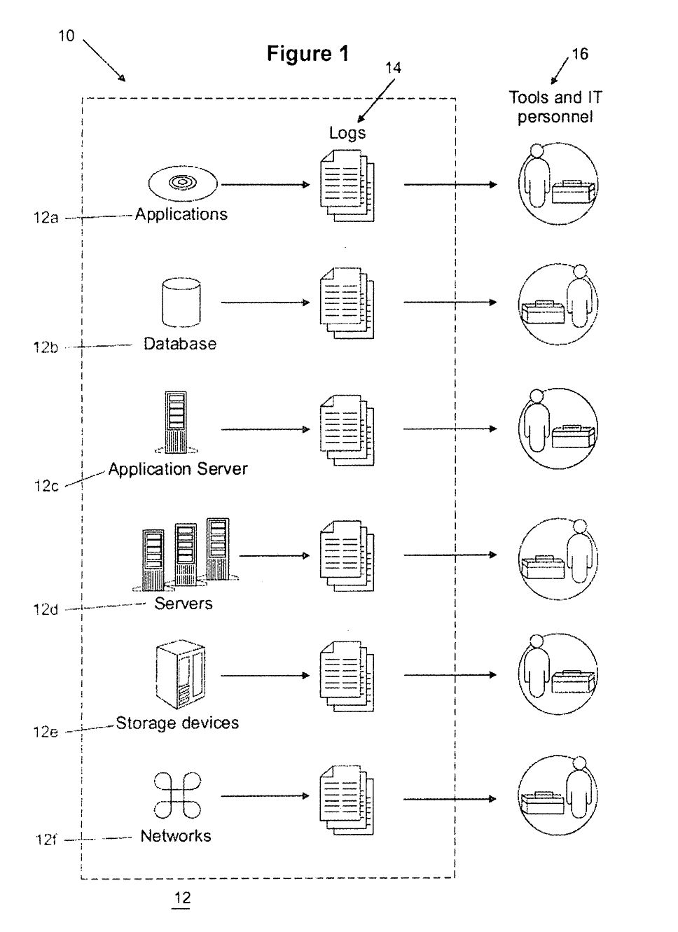

Turning now to the drawings in greater detail, it will be seen that FIG. 1 illustrates an exemplary embodiment of a problem determination reporting environment within a distributed computing system. Reporting environment 10 comprises a number of hardware and software managed resources or system components 12 of the distributed computing system. Components 12 are shown as being compartmentalized into the categories of application modules 12a, a database 12b, an application server 12c, system servers 12d, system storage devices 12e, and system networks 12f, each of which uses a separate data logger to capture data associated with log, trace, and message events.

When situations occur that are significant either due to a change in state such as, for example, when a server completes startup or because a potential problem with the system is detected such as, for example, a timeout waiting for a resource, components 12 interact with loggers to detect the situation, log the event data that is related to a situation, and create log records, which are the container objects for the data of the event that indicates the occurrence. Each log record is a structured notification that reports three kinds of information: 1) data regarding the situation that has occurred; 2) the identity of the affected component (for example, a server that crashed); and 3) the identity of the component that is reporting the situation.

Each logger then proceeds to send the log record object that captured the data to a respective log handler of a plurality of log handlers 14 within exemplary logging environment 10. In exemplary embodiments, loggers can have zero or more associated log handlers. Where supplied, all events that are logged are passed to the attached log handlers. In exemplary embodiments, each logger can include a filter that is invoked for each incoming event to instruct the logger whether or not to ignore it, so as to focus only on relevant situations.

Log handlers 14 are program modules that are configured to output log record objects, or log files, to any number of output devices 16 for analysis using log analysis tools and other problem isolation modules using a standard message format for each log analysis tool with additional data such as, for example, a date and time stamp that are added automatically. In the present exemplary embodiment, each log handler is associated with a single resource, such as the log handler for application server 12c, or associated with a related resource bundle, such as the log handler for applications modules 12a.

In exemplary embodiments, handlers can be configured with a specified level, which the handler compares to the level that is specified in each logged object received. If the level of the logged object is less severe than the level set in the handler, the handler ignores the object. Additionally, in exemplary embodiments, handlers can have a filter, which, if supplied, is invoked for each incoming object to instruct the handler whether or not to ignore it. Furthermore, in exemplary embodiments, handlers can be provided with a formatter, which is responsible for rendering the event for output and therefore controls how the logged objects are formatted. For example, the formatter can decide to first include the time stamp, followed by a string representation of the level, followed by the message that is included in the logged object. This formatted representation is what the handler writes as a log file to the output device.

Exemplary embodiments of the present invention are directed to techniques for mapping logically-related sets of log files between different log analysis tools (for example, Rich Client Platform Log Analyzer, Portal Log Analyzer, Eclipse Log and Trace Analyzer, SWG Tooling, etc.) so that information generated from one log analysis tool can be used by other analysis tools. Exemplary embodiments of the present invention utilize context generation mechanisms to generate application-related context information.

Exemplary embodiments of the present invention may be implemented as or in conjunction with a web service program on a web service provider. Web services are self-contained, self-describing, modular applications that can be described, located, and invoked over a computer network such as the World Wide Web. Web services utilize standardized interfaces and protocols (for example, a Web Application Programming Interface (API)) to implement integration methods that allow different entities or web-based applications to communicate data, logic, and processes with one another over a network. These standardized methods permit different applications to exchange resources with other entities or applications that are running on different operating systems.

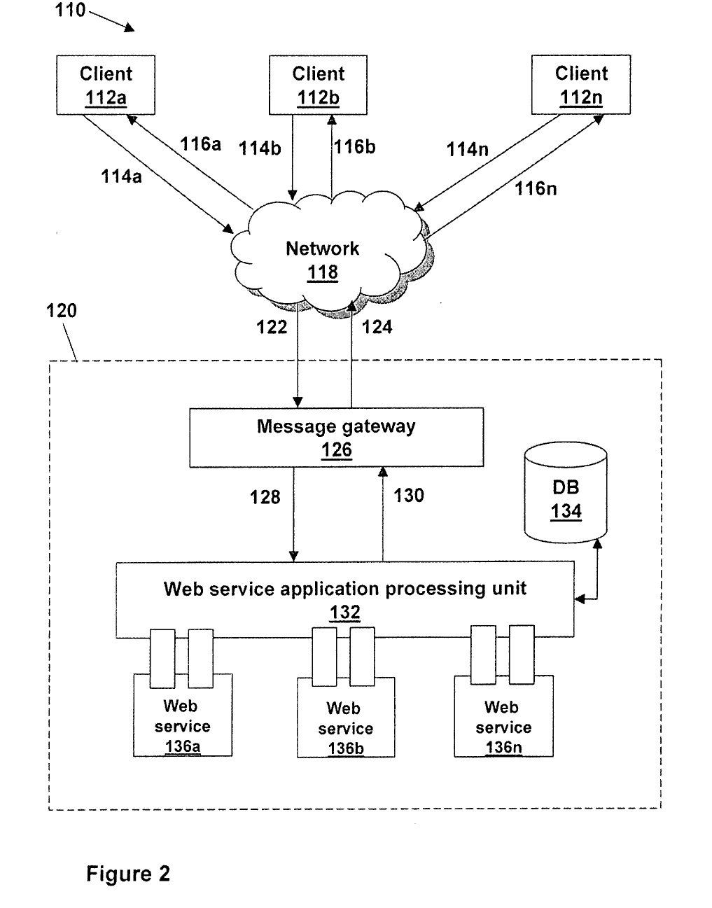

FIG. 2 is a block diagram illustrating an exemplary web service system 110 in which exemplary embodiments of the present invention may be implemented and operate. Web service system 110 allows for the exchange or transport of web service data or web service messages between multiple web service client applications (112a, 112b-112n) to any of multiple web services (136a, 136b-136n) hosted by a web service application server or provider 120. Client applications 112 are software applications that include one or more sequences of instructions that are executable by one or more processors. For example, applications 112 may be programs that are executable on a computer system such as the system illustrated in FIG. 7, described below. Web services 136 may include some combination of programming and data that are made available through application server 120 for end users and other network-connected application programs.

When a client application needs to invoke a remote web service at application server 120, the invoking client application generates a request message in a web services protocol describing arguments to be given to the web services, and requests processing by the web services. Upon receiving the request message, application server 120 performs the processing for the requested web services, and returns a response message describing return values of the web services to the client application. In exemplary web service system 110, client applications 112a, 112b-112n respectively send web service request messages 114a, 114b-114n and receive web service response messages 116a, 116b-116n.

Client applications 112 and web services 136 communicate with each other, as well as with to other applications and web service systems, through a communications network 118. Network 118 is configured to receive and pass on request response messages 114 and 116 accordingly, and to use the transportation protocol or protocols used by messages 114 and 116. Network 118 includes intranets, extranets, and the Internet, and may contain any number of network infrastructure elements including routers, switches, gateways, etc. For example, network 118 may be the public Internet or a private LAN.

Application server 120 provides web services 136 to client applications 112 through network 118. A web server application processing unit 1312 (such as WebSphere, a product of International Business Machines Corporation) oversees the execution of multiple web services 136a, 136b-136n that reside on application server 120. Network 118 passes each of request messages 114 as a request message 122 to and receives each of response messages 116 as a response message 124 from application processing unit 132 through a message gateway or firewall 126. Message gateway 126 receives request message 122 from network 118, and passes response message 124 to the network. Message gateway 126 performs lexical analysis of request message 122 to create an input object 128 including parameters for invocation of one or more of web services 136. Message gateway 126 sends input object 128 to web service application processing unit 132, which calls the appropriate web service(s) that correspond(s) to the method invocation of the input object, executes the appropriate logic, and returns the result as an output object 130 that includes the return values of the invoked web service(s), to the message gateway. Message gateway 126 converts output object 130 into response message 124, and transmits the response message through network 118 to the invoking client application.

Application processing unit 132 may also be supported by a database management system 134, which may be any conventional data repository for storing, managing, and retrieving data. In exemplary embodiments, database 134 may be a relational or object-relational database management system, such as DB2, a product of International Business Machines Corporation. In exemplary embodiments, database 134 may be internal to application server 120 (as shown in FIG. 2) or, alternatively, reside externally on a separate machine. In exemplary embodiments, application server 120 may use a single database 134 to serve multiple web services 136 (as shown in FIG. 2) or, alternatively, use a separate database for each separate web service.

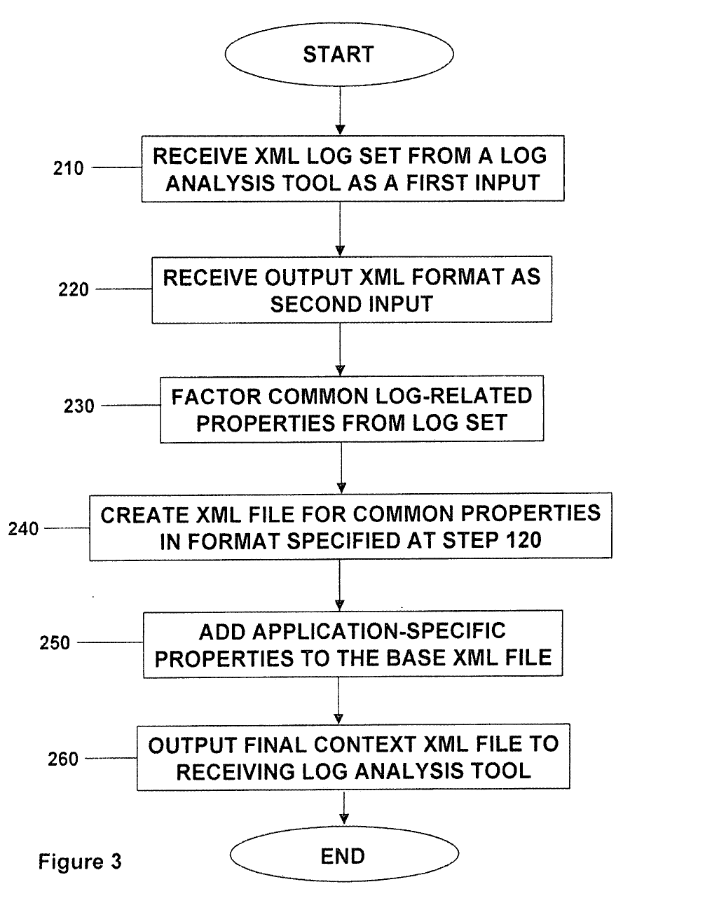

FIG. 3 illustrates the process and control flow of an exemplary embodiment of the present invention as performed by a context information generator that is implemented to operate as a web service. The features of the web service implementations described herein should not be taken as limiting the invention, and it should be noted that exemplary embodiments can be implemented on or in conjunction with other computer systems that have different features or structures than the examples provided herein.

In the exemplary process and control flow of FIG. 3, indicated generally by 200, a context generator module operates as a web service provided by a web service application server (for example, application server 120 of FIG. 2) by receiving a set of XML (extensible markup language) files from a log analysis tool and generating an application-specific XML file as output. XML is an open, industry standard that provides a general, data model-oriented framework for the development and storage of application-specific languages and information that can be represented as a tree-based data structure. The XML files received as input by the context generators have been generated from a log analysis tool and together define a logically related set of log files, or log set. The context generator processes the log set in accordance with an output XML format to generate the output application-specific XML file, which contains the log set information in a format that may be used by a specified one of any number of problem determination log analysis tools.

More specifically, the process begins by receiving a first input at step 210 and a second input at step 220. The first input is the log set, which is a logically related set of XML log files or, in some instances, a single XML log file. The first input is received from a log analysis tool. The second input is an output XML format.

The log files of the first input at step 210 have been formatted in accordance with an XML format that is suitable for use by the specific log analysis tool from which the log files were submitted. Each log file is a nonempty set of one or more of log data, metadata, and application-specific data. Log data refers to specific information regarding the event that has occurred. Log data can be generated in conjunction with each other or independent of each other. Metadata is data about log data as expressed in the XML formatting of the log file. That is, metadata refers to information that is used to facilitate the understanding, use, and management of, or otherwise qualify, the log data and may not bear significant value on its own. Examples of metadata can include the time and location of capture of log data and the relationships between the log data. Application-specific data refers to the other properties defined within the XML format of the log file that are not related to the log data. That is, application-specific data refers to information expressing a context in a format interpretable by the log analysis tooling for which the log files were generated. Application-specific data may have been generated by, for example, a formatter implemented with a log handler.

At step 220, the second input simply provides the XML format of the log analysis tool to which the context generator will be sending a log file. In addition, application-specific data that refers to information expressing a context in a format interpretable by the log analysis tooling to which the context generator that will be sending a log file can be supplied based upon pre-defined defaults stored within the web service system, or, in optional exemplary embodiments, as a third input that is specified by a user.

The context generator then proceeds to step 230, at which it identifies the context for which the log files were generated and factors out the common log-related properties and corresponding data for those properties from the application-specific data within the log files. These common log-related properties are specified by the metadata and the log data within each log file and can include, for example, the name or identifier of the log set and the child log files of the log files currently being processed.

In the present exemplary embodiment, the common log-related properties are identified using XML Schema Definitions for various log analysis tools such as, for example, Rich Client Platform Log Analyzer, Portal Log Analyzer, Eclipse Log and Trace Analyzer, etc., that input log sets to the context generator at step 110 in various iterations of process 100. An XSD is a standard schema language that defines a type of XML document in terms of constraints upon the elements and attributes that may appear, their relationship to each other, the types of data that may occur, etc. In exemplary embodiments, the XSDs can come directly from built-in XML Schema Datatypes within the software of the log analysis tools and used to identify the common log-related properties without further modification. In alternative exemplary embodiments, the XSDs can be defined within the context generator based upon the metadata as specified by XML properties that are input at step 210.

With the common properties shared by the XSDs defined and identified in the log set, the common properties shared among the XSDs can be factored out of each set of logically related log files at step 130. During operation of the context generator, all properties related to log sets and log files belonging to the log sets that were factored out as common properties shared by the XSDs can then be used as a common base set for building XML files for other tools that analyze log sets during further iterations of exemplary process 200.

Once the common log-related properties have been factored out from the log files, the context generator, at step 240, proceeds to create a base XML log file consisting of these common log-related properties as defined by the XSDs. Thus, the common log set properties that were factored out at step 230 are then used as a common base for building XML files in a format that is interpretable by the application to which the output XML file will be submitted. That is, the base XML file is created in the XML format that was specified by the second input at step 220.

In exemplary embodiments, to define the XSDs and create a base XML log file containing only the common log-related properties at step 240, the context generator can utilize a web service interface. For example, the context generator can use a Web Services Description Language (WSDL) interface to create a base XML log file containing only these common log-related properties. WSDL is an XML format that provides a model for describing web services and what they offer as a set of endpoints operating on messages containing either document-oriented or procedure-oriented information. The operations and messages are described abstractly, and then bound to a concrete network protocol and message format using context information to define an endpoint.

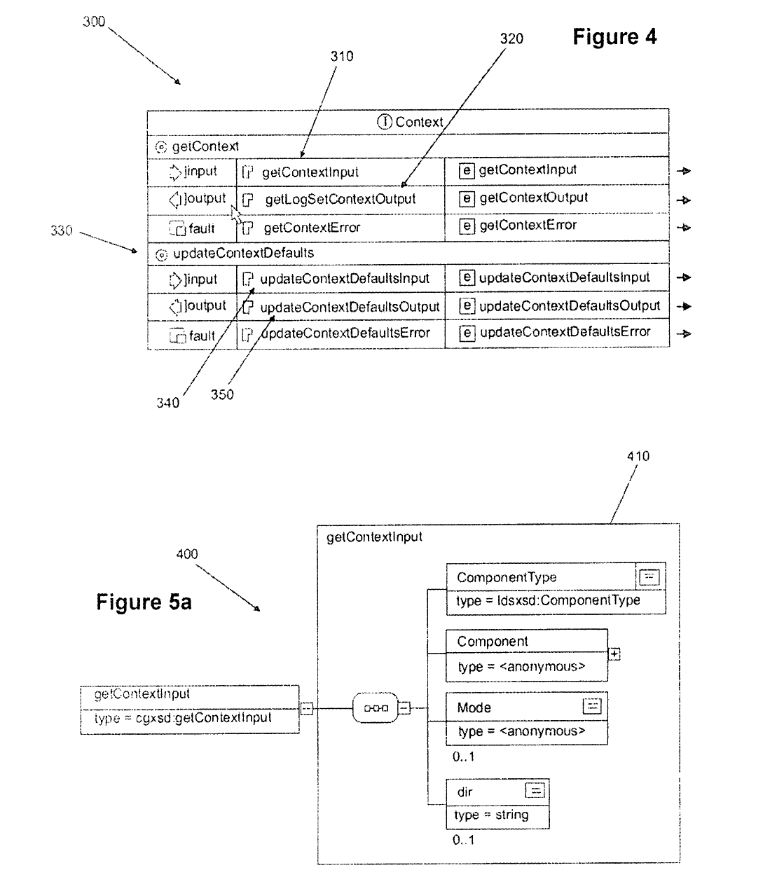

In exemplary embodiments, the WSDL interface utilized by the context generator can be defined using WSDL version 1.1 or version 2.0. FIG. 4 illustrates an exemplary embodiment of the graphical WSDL interface defining the context generator web service. WSDL interface 300 is configured to provide a set of operations for generating context information for a given log set, as well as for updating default context information in the XSDs. In the present exemplary embodiment, the getContextInput operation, which is indicated at 310, returns a set of inputs specifying the component type (that is, the log analysis tool) and component details for which to generate context information. For generating log set information for a component, can be a complete log set, or an individual log file. The getContextOutput operation, which is indicated at 320, returns the log set information context file that was generated by the context generator according to the inputs to the getContextInput operation.

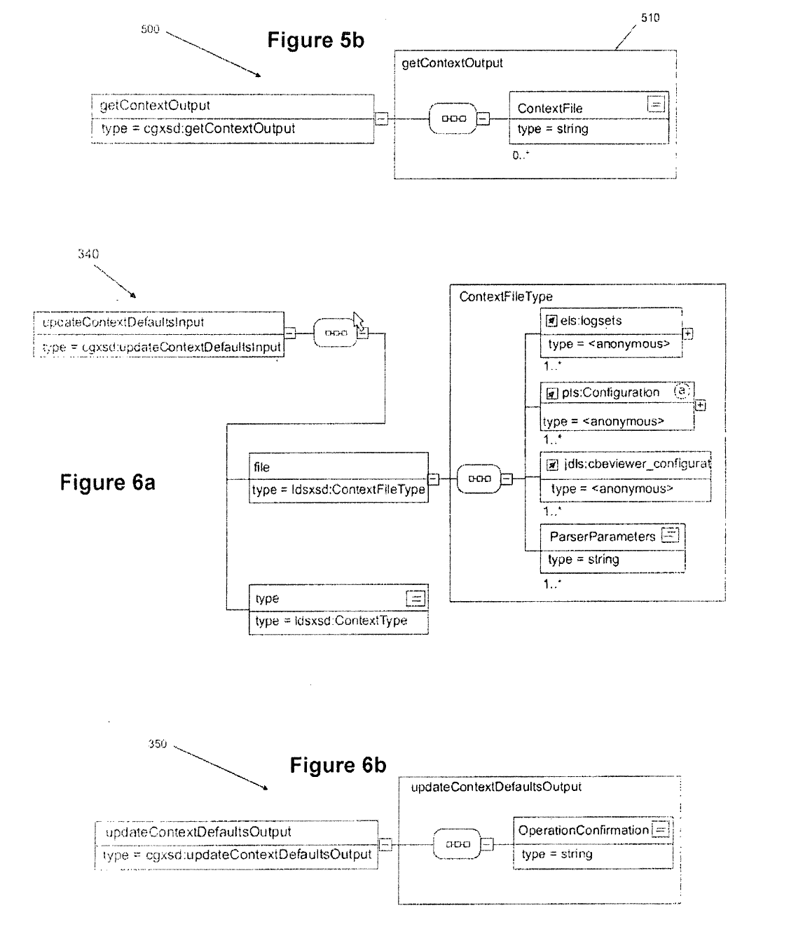

FIG. 5a graphically depicts the function call to the getContextInput operation, indicated generally at 400. The set of input parameters are indicated at 410. Mode and dir are optional inputs specifying whether the context is to be generated based on information that is stored locally or information that is stored remotely. FIG. 5b graphically depicts the function call of the getContextOutput operation, indicated generally at 500. The output parameter, which is the application-specific XML file generated according to the context information supplied in this implementation, is indicated at 510.

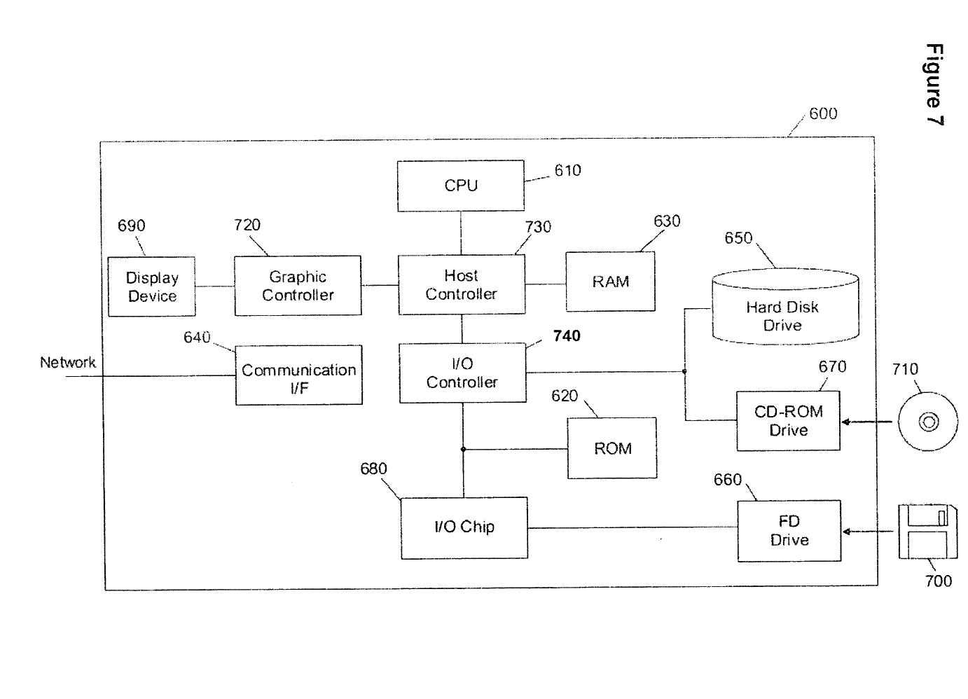

In exemplary embodiments, an optional operation object that can be included in the WSDL service interface is updateContextDefaults, indicated at 330 in FIG. 4, which allows for application-specific properties to be pre-defined in XML format using the updateContextDefaultsInput operation, which is indicated at 340, and to be read and integrated into the base XML file using updateContextDefaultsOutput, indicated at 350, to generate the application-specific XML file (for instance, at step 250 described below of the exemplary embodiment illustrated FIG. 3). Example input and output parameters to and from updateContextDefaultsInput operation 340 and updateContextDefaultsOutput operation 350 provided within the updateContextDefaults object are illustrated in FIGS. 6a and 6b respectively.

Referring back to the exemplary process in FIG. 3, at step 250, the context generator proceeds to add the application-specific properties to the base XML file in accordance to the existing tooling XSD of the log analysis tool specified by the second input at step 220. In addition, in optional exemplary embodiments, application-specific properties can be specified according to context information within pre-defined defaults and/or user input at a third input step. As described above, in exemplary embodiments, the context generator can contain a set of pre-defined XML files defining application-specific properties that are added to the base XML log set file at this step. The context generator creates the final XML file containing the log set information in a format suitable for use by log analysis tooling configured to interpret files in the XML format specified by the input at step 220.

Finally, at step 260, the context generator sends the output XML file that was created at step 250 to the desired log analysis tool.

Implementing this context generation system as a web-service, as in the present exemplary embodiment, allows for the context generator system to be easily extensible to include new XSDs by defining a new datatype for each new log analysis tool format that is specified for an input to or an output from the system. To extend the system to include other data formats in this manner, the context generator first defines a new data format as an XSD, then extends the WSDL interface to accept the new datatype as formats for input and output XML files, and finally adds the appropriate logic for mapping the common properties of the XSDs in the service interface. Therefore, the context generator can be further extended to support additional formats simply by modeling the new formats using XML schema, and mapping the common elements in relation to the other log sets.

Exemplary embodiments of techniques and mechanisms for factoring out common properties in a logically-related set of log files and generating application-specific XML files for processing can be implemented to perform a context function for mapping other forms of analysis data between applications that are configured to interpret the analysis data in differing context formats.

The capabilities of exemplary embodiments of present invention described above can be implemented in software, firmware, hardware, or some combination thereof, and may be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. Exemplary embodiments of the present invention can also be embedded in a computer program product, which comprises features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Therefore, one or more aspects of exemplary embodiments of the present invention can be included in an article of manufacture (for example, one or more computer program products) having, for instance, computer usable media. The media has embodied therein, for instance, computer readable program code means for providing and facilitating the capabilities of the present invention. The article of manufacture can be included as a part of a computer system or sold separately. Furthermore, at least one program storage device readable by a machine, tangibly embodying at least one program of instructions executable by the machine to perform the capabilities of the exemplary embodiments of the present invention described above can be provided. To illustrate, FIG. 7 shows a block diagram of an exemplary embodiment of a hardware configuration for a computer system, representing web service application server 120 in FIG. 2, through which exemplary embodiments of the present invention can be implemented.

As illustrated in FIG. 7, computer system 600 includes: a CPU peripheral part having a CPU 610 that accesses a RAM 630 at a high transfer rate, a display device 690, and a graphic controller 720, all of which are connected to each other by a host controller 730; an input/output part having a communication interface 340, a hard disk drive 650, and a CD-ROM drive 670, all of which are connected to host controller 730 by an input/output controller 740; and a legacy input/output part having a ROM 620, a flexible disk drive 660, and an input/output chip 680, all of which are connected to input/output controller 740.

Host controller 730 connects RAM 630, CPU 610, and graphic controller 720 to each other. CPU 610 operates based on programs stored in ROM 620 and RAM 630, and controls the respective parts. Graphic controller 720 obtains image data created on a frame buffer provided in RAM 630 by CPU 610 and the like, and displays the data on the display device 690. Alternatively, graphic controller 720 may include a frame buffer that stores image data created by CPU 610 and the like therein.

Input/output controller 740 connects host controller 730 to communication interface 640, hard disk drive 650, and CD-ROM drive 670, which are relatively high-speed input/output devices. Communication interface 640 communicates with other devices through the network. Hard disk drive 650 stores programs and data that are used by CPU 610 in computer 600. CD-ROM drive 670 reads programs or data from CD-ROM 710 and provides the programs or the data to hard disk drive 650 through RAM 630.

Moreover, ROM 620, flexible disk drive 660, and input/output chip 680, which are relatively low-speed input/output devices, are connected to input/output controller 740. ROM 620 stores a boot program executed by computer 600 at its start, a program dependent on the hardware of the computer, and the like. Flexible disk drive 660 reads programs or data from flexible disk 700 and provides the programs or the data to hard disk drive 650 through RAM 630. Input/output chip 680 connects the various input/output devices to each other through flexible disk drive 660 and, for example, a parallel port, a serial port, a keyboard port, a mouse port and the like.

The programs provided to hard disk drive 650 through RAM 630 are stored in a recording medium such as flexible disk 700, CD-ROM 710, or an IC card. Thus, the programs are provided by a user. The programs are read from the recording medium, installed into hard disk drive 650 in computer 600 through RAM 630, and executed in CPU 610.

A program that is installed into computer 600 and allows the computer to function as, for example, web service application server 120 of FIG. 2 includes a message parsing module, a message filtering module for security processing, a message processing module, and a web service application processing module. The above-described program or modules implementing exemplary embodiments of the present invention can work on CPU 610 and the like and allow computer 600 to function as the context generator described in the exemplary embodiments described above.

The program or modules implementing exemplary embodiments may be stored in an external storage medium. In addition to flexible disk 700 and CD-ROM 710, an optical recording medium such as a DVD and a PD, a magneto-optical recording medium such as a MD, a tape medium, a semiconductor memory such as an IC card, and the like may be used as the storage medium. Moreover, the program may be provided to computer 600 through the network by using, as the recording medium, a storage device such as a hard disk or a RAM, which is provided in a server system connected to a dedicated communication network or the Internet.

Although exemplary embodiments of the present invention have been described in detail, it should be understood that various changes, substitutions and alternations can be made therein without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the present invention.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments of the present invention have been described, it will be understood that those skilled in the art, both now and in the future, may make various modifications without departing from the spirit and the scope of the present invention as set forth in the following claims. These following claims should be construed to maintain the proper protection for the present invention.

What is claimed is:

1. A method for mapping analysis data between a first data analysis tool configured to interpret analysis data expressed in a first format to a second data analysis tool configured to interpret analysis data expressed in a second format, the method comprising:
receiving a set of analysis data expressed in the first format from the first data analysis tool;
receiving an indication of the second format;
identifying a set of common analysis data from the set of analysis data using a set of common analysis data properties and a first context, the first context providing a set of rules for expressing the set of common analysis data properties in the first format; and
generating a representation of the set of common analysis data in the second format using a second context, the second context providing a set of rules for expressing the set of common analysis data properties in the second format.

2. The method of claim 1, further comprising sending the representation of the set of common analysis data in the second format to the second data analysis tool.

3. The method of claim 1, further comprising adding a set of context properties specific to the second format to the representation of the set of common analysis data in the second format using a third context, the third context providing a set of rules for expressing the set of context properties in the second format.

4. The method of claim 1, wherein the set of analysis data comprises a logically related set of log files containing problem determination data, and wherein the first and second data analysis tools are problem determination log file analysis tools.

5. The method of claim 1, wherein the first context is at least partially provided by pre-defined default settings.

6. The method of claim 1, further comprising receiving at least part of the first or second context.

7. The method of claim 6, wherein the at least part of the first or second context is specified by a user.

8. The method of claim 6, wherein the at least part of the first or second context is specified by context information within the first or second analysis tool.

9. The method of claim 1, wherein the first and second formats are XML formats, and wherein the first and second contexts are XML Schema Definitions.

10. The method of claim 1, wherein the method is performed by a web service on a web service application provider.

11. The method of claim 10, wherein the method is performed by the web service using operations provided a Web Services Description Language interface.

12. A computer-usable medium having computer readable instructions stored thereon for execution by a processor to perform a method for mapping analysis data between a first data analysis tool configured to interpret analysis data expressed in a first format to a second data analysis tool configured to interpret analysis data expressed in a second format, the method comprising:
receiving a set of analysis data expressed in the first format from the first data analysis tool;
receiving an indication of the second format;
identifying a set of common analysis data from the set of analysis data using a set of common analysis data properties and a first context, the first context providing a set of rules for expressing the set of common analysis data properties in the first format; and
generating a representation of the set of common analysis data in the second format using a second context, the second context providing a set of rules for expressing the set of common analysis data properties in the second format.

13. A data processing system comprising:
a central processing unit;
a random access memory for storing data and programs for execution by the central processing unit;
a first storage level comprising a nonvolatile storage device; and
computer readable instructions stored in the random access memory for execution by central processing unit to perform a program for mapping analysis data between a first data analysis tool configured to interpret analysis data expressed in a first format to a second data analysis tool configured to interpret analysis data expressed in a second format, the method comprising:
receiving a set of analysis data expressed in the first format from the first data analysis tool;
receiving an indication of the second format;
identifying a set of common analysis data from the set of analysis data using a set of common analysis data properties and a first context, the first context providing a set of rules for expressing the set of common analysis data properties in the first format; and
generating a representation of the set of common analysis data in the second format using a second context, the second context providing a set of rules for expressing the set of common analysis data properties in the second format.
